(19) United States
(12) Patent Application Publication
(10) Pub. No.: US 2015/0012568 A1
(43) Pub. Date: Jan. 8, 2015

(54) HIERARCHICAL CONTENT MANAGEMENT AND PRESENTATION APPLICATION

(71) Applicant: Scott Rens, Lino Lakes, MN (US)

(72) Inventor: Scott Rens, Lino Lakes, MN (US)

(21) Appl. No.: 13/935,731

(22) Filed: Jul. 5, 2013

(51) Int. Cl. G06F 17/30

(52) U.S. Cl. CPC G06F 17/30312
USPC 707/812

(57) ABSTRACT

A system and method includes defining first characteristics of a first organization. The first characteristics include a first selected set of content data stored on a data server. The method further includes permitting an end user to associate with the first organization by creating a user record within the first characteristics that belongs to the end user, storing the first characteristics on the data server, administering the first characteristics through an electronic access device, and analyzing data elements of the first selected set of content data accessed by the end user.

### BACKGROUND

The present invention is related to content management and content presentation, and in particular to a system and method for providing content management, filtering and presentation using a hierarchical, organizational system.

The internet or world wide web provides access to a wide variety of content. Search engines have typically been utilized by users to find and access desired content on the internet. A typical search engine provides a tool that allows users to search large collections of electronic content for relevant material. The search engine uses the search terms provided by a user to locate relevant content.

Additionally, content hosting applications exist to provide a specific set of content to a user. Search engines may be utilized within content hosting applications, or users may select from content presented by the application. However, as the amount of content accessible on the internet or included within content hosting applications increases, the task of obtaining relevant content becomes more difficult for both the application and the end user. Oftentimes, the search engine or content hosting application will provide thousands of documents deemed relevant to a particular user's interest. This requires a user to sort through a large amount of content to locate the desired content. Further, search engines or content hosting applications offer very little in the way of personalized content production and presentation.

Therefore, it would be beneficial to provide an improved method of providing desired content to an end user.

### SUMMARY

A method includes defining characteristics of an organization that include a set of data elements associated with the organization, storing the characteristics of the organization in a database, establishing a relationship between the organization and an end user, storing the relationship in the database, providing access to the set of data elements stored in the database to the end user based upon the relationship, and accessing the data elements through an electronic device controlled by the end user.

In another embodiment, a system includes a user tier, a data storage tier, and an application tier. The user tier includes a first electronic access device controlled by an end user. The data storage tier includes application data and content data stored in a database. The application data includes first characteristics defining a first organization. The first characteristics include a first set of data elements of the content data associated with the first organization. The application tier includes interface components that interface with the first electronic access device to allow access to the data storage tier. Access to the first set of data elements through the first electronic access device is permitted based upon a first established relationship between the end user and the first organization.

In another embodiment, a method includes defining first characteristics of a first organization. The first characteristics include a first selected set of content data stored on a data server. The method further includes permitting an end user to associate with the first organization by creating a user record within the first characteristics that belongs to the end user, storing the first characteristics on the data server, administering the first characteristics through an electronic access device, and analyzing data elements of the first selected set of content data accessed by the end user.

### BRIEF DESCRIPTION OF THE DRAWINGS

FIG. 1 is a block diagram illustrating a software and hardware architecture for a hierarchical content management and presentation system.

FIG. 2 is a block diagram illustrating relationships in a hierarchical content management and presentation system.

FIG. 3 is a flowchart illustrating a method of performing content management and presentation using a hierarchical system.

FIG. 4 is a flowchart illustrating a method of administering groups in a hierarchical content management and presentation system.

### DETAILED DESCRIPTION

A system and method for providing content management and presentation is disclosed herein that includes hierarchical relationships between end users and organizations. The system may be implemented as a “cloud-based” software-as-a-service (SaaS) application that creates, manages, and monitors content and/or learning paths for individuals and organizations. Content is provided to, or selected for a user based upon the user's affiliation with organizations. These organizations are defined within the application and may include local organizations, parent type organizations, grandparent type organizations, peer type organizations, or other organizations in a field of interest. Content for the users may be created by the organizations, or selected from general content available on the internet or external systems that may be of interest to the user.

Organizations may develop content to educate, teach, or reach all people affiliated with their organization, and draw feedback and analytics from all the end users of their group to monitor progress and assist in further development of future content. This enables the organizations to offer relevant material to educate, teach, grow, or influence the organizations' groups of users. The application can extend beyond local organizations to any parent or grandparent organizations with which the local organization has a relationship. The parent organizations may provide content to several local organizations. The parent organizations may draw analytics from the local organizations and offer customized material or content to impact the specific needs of the local organization and/or its end users. Similarly, grandparent organizations may provide content to several organizations that act as parents to local organizations, or directly to the end user. The grandparent organization has the ability to draw analytics from the organizations that act as parents to local organizations with which the grandparent has a relationship, as well as from end users in order to provide customized material for those organizations and/or users. The grandparent organization may also have the ability to draw analytics from the local organization depending upon the established relationship. Other organizations can provide content within the system as a peer organization to either the local organization, parent organizations, or grandparent organizations. These organizations establish relationships with the aforementioned organizations and provide content as well as have the ability to monitor analytics from the usage of the content they provide.

The application may also include other organizations that have no affiliation with local, parent, grandparent, or peer organizations. These organizations may establish relationships with the end user while not acting as a local organization. They may provide content to the end user based upon an established relationship, or they may provide content accessible to all users and organizations within the application on a subscription basis. These organizations may have the ability to monitor analytics from the usage of the content they provide.

The system is implemented in an exemplary embodiment with a user tier, application tier, data access tier and data storage tier. The user tier includes user access devices and administrative access devices such as laptops, tablets, smartphones, or any other electronic device. These access devices are utilized to access the SaaS application. The application tier includes user interface servers and web servers to execute the SaaS application and present the SaaS application to the end users and administrative users. The data storage tier provides storage for the application itself, along with all content created by the organizations or the end users. The data access tier interfaces between the application tier and the data tier to store and retrieve desired content for the end users and the organizations.

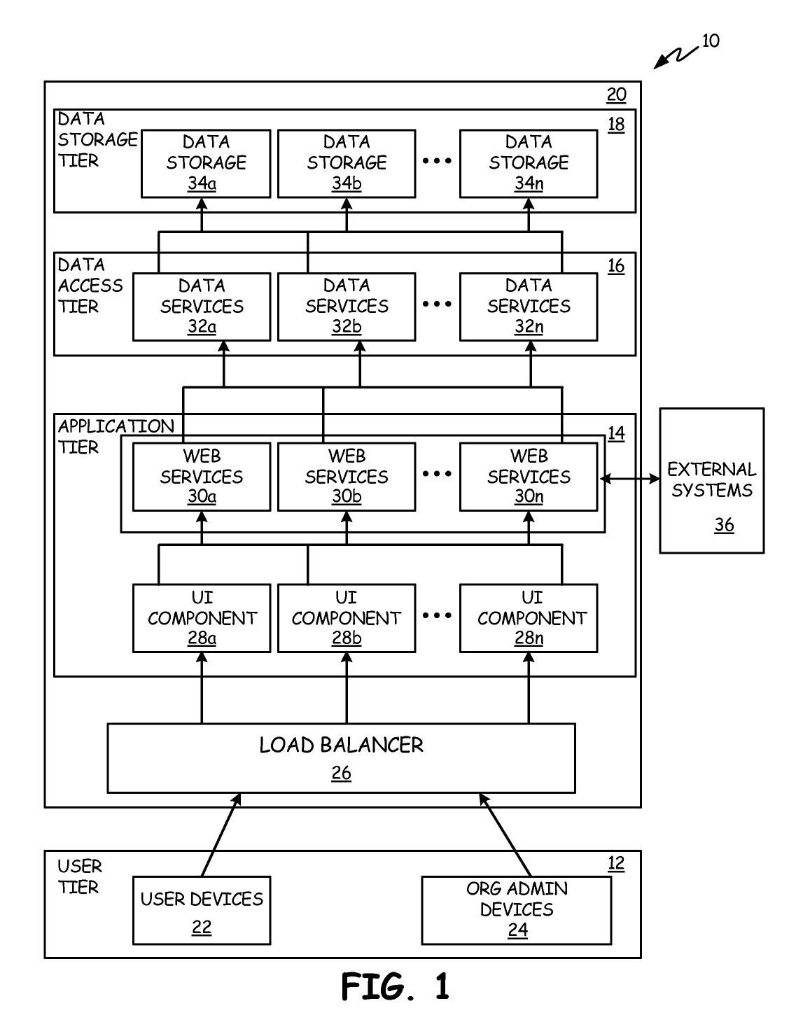

FIG. 1 is a block diagram illustrating a software and hardware architecture for hierarchical content management and presentation system 10. System 10 includes user tier 12, application tier 14, data access tier 16, and data storage tier 18. Application tier 14, data access tier 16, and data storage tier 18 are all included within application 20. User tier 12 includes user devices 22 and organization admin devices 24. Application tier 14 includes load balancer 26, user interface components 28a-28n, and web services components 30a-30n. Data access tier 16 includes data services components 32a-32n. Data storage tier 18 includes data storage components 34a-34n. Application tier 14 may communicate with external systems 36 in order to provide/receive content to/from external systems 36. Application 20 may be implemented as a “cloud-based” software-as-a-service (SaaS) application that creates, manages, and monitors content and/or learning paths for individuals and organizations.

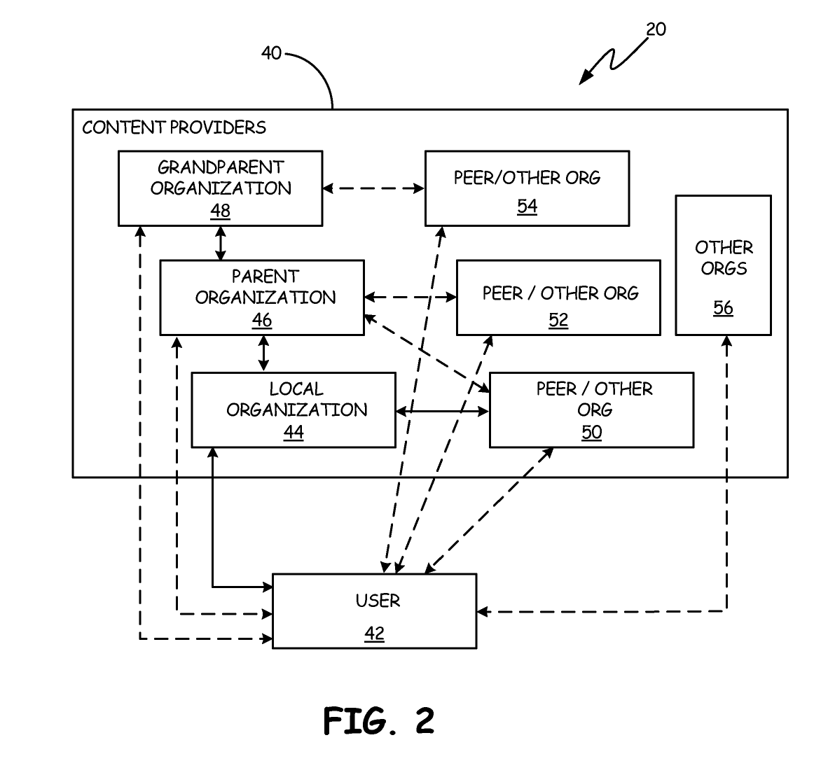

With continued reference to FIG. 1, FIG. 2 is a block diagram illustrating hierarchical relationships in application 20 of content management and presentation system 10. Content providers 40 provide content and learning tracks to user 42 based upon established relationships. Content providers 40 include local organization 44, parent organization 46, grandparent organization 48, peer organizations 50, 52, and 54, and other organizations 56. These logical organizations are defined within application 20 and stored within data storage tier 18. Although labeled as local, parent, grandparent, peer and other organizations, content providers 40 may be any organizations that may have a relationship with any end user 42 and/or any other organization. Organizations may be defined, edited, removed or maintained by one or more administrative users through organization admin devices 24. These administrators access application 20 using an administrative account stored within application 20. Use of this administrative account may be on a fee basis in some embodiments.

Content providers 40 may represent any real-world or virtual organization with which end user 42 accessing application 20 may choose to associate, such as, for example, a church, school, business, or any other organization. Each organization of content providers 40 is defined by characteristics that are stored within data storage tier 18. These characteristics are administered by, for example, administrative users that access application 20 through organization admin devices 24 of user tier 12.

User tier 12 includes user access devices 22 and organization admin access devices 24 utilized to access application 20. User devices 22 and organization admin devices 24 are any devices capable of executing software such as, for example, personal computers, laptops, tablets, or smart phones. Application 20 may be accessed through, for example, a wired or wireless internet connection, or any other wired or wireless network connection. User devices 22 and organization admin devices 24 may access application 20 through, for example, a web browser or client application software. Access to application 20 from user devices 22 and admin devices 24 may be through, for example, a user dashboard, an admin portal, or any other software user interface. End user 42 may authenticate with application 20 through an end user account. This end user account may or may not be established on a fee basis. End user 42 may authenticate with application 20 using, for example, a username and password. This end user account may be utilized to establish relationships with any of content providers 40.

Application tier 14 provides application services between user tier 12 and data access tier 16. These services may include, for example, web services. User interface components 28a-28n may be servers utilized to compile and execute software to interface with user devices 22 and admin devices 24. For example, user interface components may be physical servers or virtual machines that execute software to provide a presentation of application 20 to user devices 22 and organization admin devices 24. Software for the presentation of application 20 may be executed on user interface components 28a-28n as, for example, server-side scripts or other server-side executed software. Software may also be provided to user devices 22 and admin access devices 24 by user interface components 28a-28n to be executed as, for example, client-side scripts or any other client-side executed software. User interface components 28a-28n may also provide access to selected content on the internet that is outside of application 20 based upon the end users relationship with any of content providers 40. Any number of servers may be implemented for user interface components 28a-28 in order to accommodate any amount of user traffic from user tier 12.

Web services components 30a-30n execute software to make application 20 available to user tier 12 on a network. The network may be, for example, the internet, a local area network (LAN) or any other type of network. Web services components 30a-30n may be implemented on physical servers or may be implemented as virtual machines. Web services components 30a-30n may be implemented on the same servers or virtual machines as user interface components 28a-28n in some embodiments. Any number of servers may be implemented for web services components 30a-30n in order to accommodate any amount of user traffic from user tier 12.

Web services components 30a-30n may communicate with external systems 36 to provide or receive content to/from external systems 36. External systems 36 are any systems external to application 20 and may include, among others, web sites, hosting applications, external domains, or any other external system. Content provided by external systems 36 may include, for example, podcasts, music, or any other content available external to application 20. For example, if content is generally available on the internet, web services components 30a-30n may link to that content. If content is available in a separate application or system, application 20 may perform cross-site authentication to retrieve content from external systems 36. Web services components 30a-30n may communicate with external systems 36 through, for example, a network connection. The network may be, for example, the internet, a LAN, or any other type of network.

Load balancer 26 handles client requests from user access devices 22 and admin access devices 24 to distribute traffic to user interface components 28a-28n and/or web services components 30a-30n. Load balancer 26 may be implemented as a server, a virtual machine, or any other suitable device. Load balancing may be performed in software, hardware, or both. In another embodiment, application tier 14 does not include load balancer 26 and client requests go directly to user interface components 28a-28n and/or web services components 30a-30n.

Application tier 14 also executes application 20. Content providers 40 may administer learning tracks for users 42 and monitor analytics for data accessed by users 42. Application 20 monitors data usage for each user 42 and provides analytics to respective organizations. For example, end users 42 accessing application 20 through user devices 22 access data elements stored in data storage tier 18. Content providers 40 have a record of the data elements accessed. An administrator of each content provider 40 can monitor usage statistics for each data element it has provided in order to refine or expand the content it provides.

Data access tier 16 provides a software access layer between application tier 14 and data storage tier 18. Data accesses from data access tier 16 may implement any known database protocol, file system, or any other software implementation for accessing physical data. Data requests may be received from application tier 14. These requests are processed and data elements are retrieved from or stored to data storage tier 18 based upon the request. Retrieved data is provided back to application tier 14.

Software is executed for data access tier 16 on data services components 32a-32n. Components 32a-32n may be implemented on, for example, servers or virtual machines. There may be any number of data services components 32a-32n necessary to handle data requests and data transfers between application tier 14 and data storage tier 18. Components 32a-32n may be, for example, implemented on the same devices as user interface components 28a-28n, and web services components 30a-30n.

Data storage tier 18 handles all data storage for application 20. Data storage tier 18 may include, for example, all application data for application 20, data for a content library, a digital application (app) store, or any other data elements that content providers 40 would like to make available to end users 42. Data is stored on data storage components 34a-34n. Storage components 34a-34n may be, for example, hard disks, storage arrays, or virtual storage devices. Data storage components 34a-34n may be implemented on the same physical devices as data services components 32a-32n. Any number of data storage components 34a-34n may be implemented within system 10 based upon the necessary amount of data to be stored for application 20.

The relationship between end user 42 and local organization 44 may be established by an administrator of local organization 44 approving the relationship. Alternatively, local organization 44 may accept proposed relationships with any end user 42. End user 42 may or may not already have an end user account with application 20. If user 42 does not already have an account with application 20, local organization 44 may create a user account for end user 42. This created user account may or may not be on a fee basis. This created user account may then be utilized by end user 42 to access application 20 and establish relationships with any of content providers 40. A user record is created for user 42 indicative of the established relationship between local organization 44 and end user 42. This user record is stored within data storage tier 18. User 42 may authenticate its relationship with local organization 44 using, for example, a username and password.

Local organization 44 provides content to user 42 from, for example, a content library implemented in data access tier 16 and data storage tier 18, or the internet. Local organization 44 may provide default content, user specific content, or any other set of content to end users based upon, for example, the respective user's role or function within local organization 44. This content may be, for example, interactive content to provide learning paths for user 42. An administrator of local organization 44 may monitor the data usage of user 42 using, for example, any known data analytics method. The administrator of local organization 44 may expand or refine data elements available to user 42 based upon data usage of user 42. The content provided to end user 42 may be tailored specifically to end user 42 and differ from the content provided to any other end user. Each end user that has an established relationship with local organization 44 may receive their own tailored content or may, for example, receive default content.

A free or fee-based relationship between local organization 44 and parent organization 46 may be established by administrators of the respective organizations. A record is created and stored in data storage tier 18 indicative of the relationship between local organization 44 and parent organization 46. Characteristics of parent organization 46 may be defined to provide specific content to local organization 44. Local organization 44 may choose to make all or a subset of the specified content available to end users 42. The content made available to end users 42 may differ between users based upon, for example, the respective user's role or function. End user 42 may also directly establish a free or fee-based relationship with parent organization 46 to directly receive content from organization 46. Parent organization 46 may also provide content directly to the content library or the app store within application 20. This content may be available for access by an end user 42 on a free or fee-based basis.

A free or fee-based relationship between parent organization 46 and grandparent organization 48 may be established by administrators of the respective organizations. A record is created and stored in data storage tier 18 indicative of the relationship between parent organization 46 and grandparent organization 48. Characteristics of grandparent organization 48 may be defined to provide specific content to parent organization 46. Parent organization 46 may choose to make all or a subset of the specified content available to any end users 42 or content providers 40 with which parent organization has an established relationship. The content made available may differ between end users 42 based upon, for example, the respective user's role or function. The content made available to other content providers 40 may differ between organizations based upon, for example, the respective organization's roles or functions. End user 42 and/or local organization 44 may also directly establish a free or fee-based relationship with grandparent organization 48. Grandparent organization 48 may also provide content directly to the content library or the app store within application 20. This content may be available for access by an end user 42 on a free or fee-based basis.

Peer organizations 50, 52 and 54, are organizations that may not be directly related to local organization 44, parent organization 46 or grandparent organization 48, but are still organizations with which end user 42 or other content providers 40 may establish a relationship. Characteristics of peer organizations 50, 52 and 54 may be defined to provide specific content to any other organizations or end users 42 with which the peer organization has an established relationship. The peer organizations may also provide content directly to the content library or the app store within application 20. This content may be available for access by an end user 42 on a free or fee-based basis.

Other organizations 56 are organizations that may not be directly related to local organization 44, parent organization 46, grandparent organization 48, or peer organizations 50, 52, and 54, but are still organizations with which end user 42 or other content providers 40 may establish a relationship. Characteristics of other organizations 56 may be defined to provide content to end user 42 apart from the local, parent, grandparent and peer organizations. Other organizations 56 may provide content to the content library or the app store within application 20, or may provide content to end user 42 based upon an established relationship.

Application 20 may include one or more content domains. These content domains may represent, for example, groupings of content providers 40. Each content domain may include its own local, parent, grandparent, peer and other organizations. For example, one content domain may include higher education content providers 40, another content domain may include business content providers 40, and yet another content domain may include a mix of content providers 40. End users 42 may access any of the content domains that include content providers 40 with which end users 42 desire to have a relationship. The same end user account for end user 42 may or may not provide access to all content domains within application 20. Access to each content domain may or may not be on a fee basis.

In some embodiments, application 20 may include an application programming interface (API) to allow integration with application 20 for content providers 40 or end users 42. Content providers 40 may be, for example, organizations that desire to upload a large amount of content to application 20. This content may be uploaded to application 20 through the user interface which may be a time consuming process. For larger amounts of content, an interface may be created using an API of application 20 to facilitate larger content transfers. This interface may be accessed through, for example, user devices 22 or org admin devices 24. This API may also be utilized for any other desirable custom integration between content providers 40 and/or end users 42.

By implementing logical organizations within application 20, content providers 40 are able to provide personalized and directed content and learning paths to end user 42. End user 42 is also able to access more tailored content in, for example, a content library or app store implemented within application 20. By allowing local organization 44 to establish relationships with other trusted content providers 40, the content that may be available to user 42 is further expanded. User 42 does not need to search through all content on the internet to find relevant data. Instead, the relevant content is presented directly to user 42 based upon the established relationships with local organization 44 and other content providers 40. Content providers 40 are also able to refine the content provided to end users 42 based upon analytics for data accessed by end users 42.

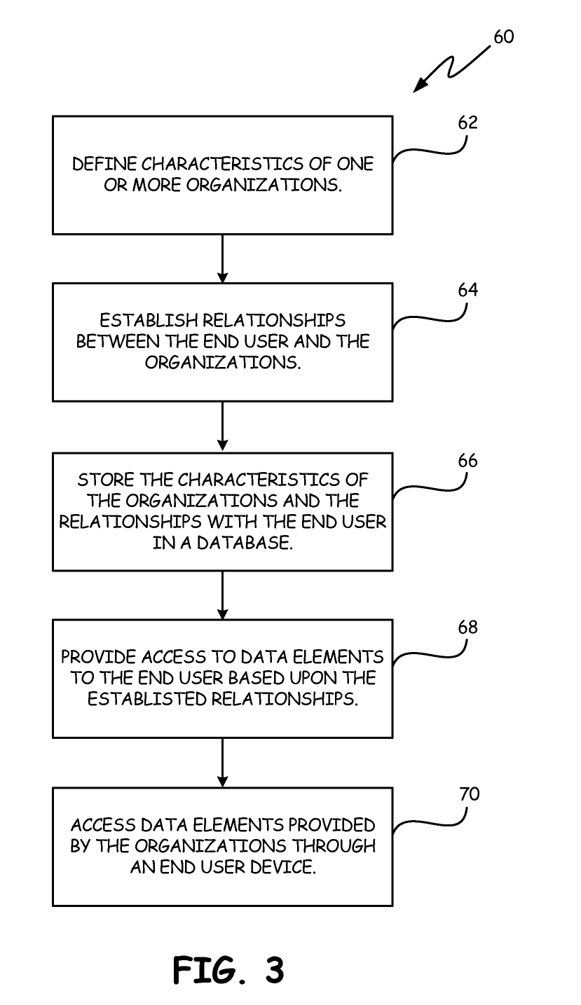

FIG. 3 is a flowchart illustrating method 60 of performing content management and presentation using a hierarchical system. At step 62, characteristics for organizations are defined within application 20. These are any organizations and may be local organizations, parent organizations, grandparent organizations, peer organizations, or any other type of organization. At step 64, relationships are established between end user 42 and the defined organizations. These relationships may be established based upon the organizations with which end user 42 desires to have relationships, as well as the relationships which the defined organizations have with other organizations. At step 66, the characteristics of the organizations as well as the established relationships are stored in data storage tier 18. At step 68, access to data elements stored in data storage tier 18 is provided to end user 42 based upon the established relationships through application tier 14. At step 70, end user 42 accesses the data elements stored in data storage tier 18 through end user devices 22.

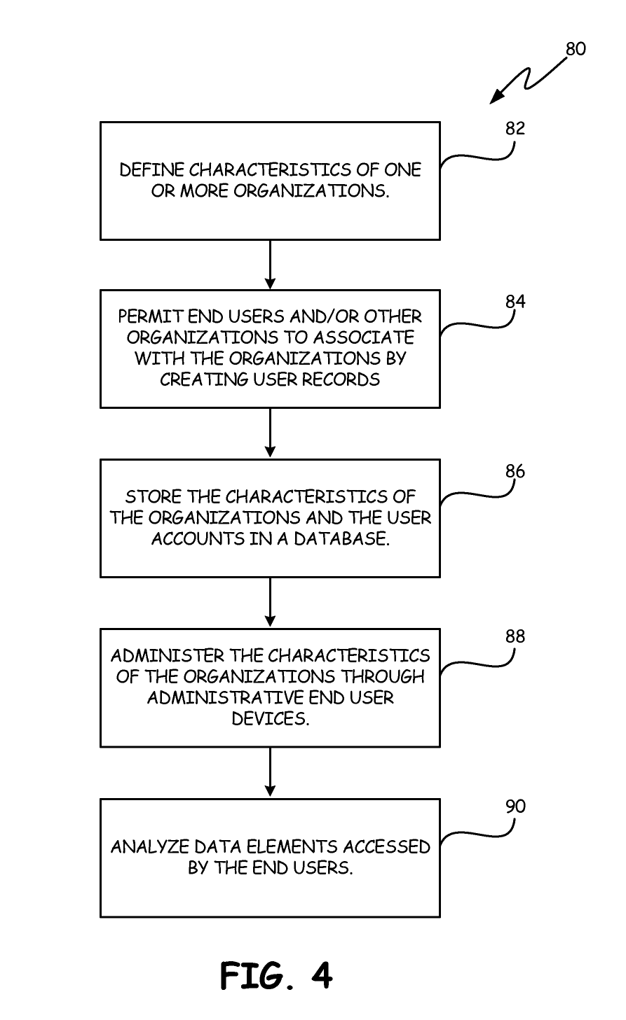

FIG. 4 is a flowchart illustrating method 80 of administering groups in a hierarchical content management and presentation system. At step 82, characteristics are defined for one or more organizations. These are any organizations and may be, for example, local organizations, parent organizations, grandparent organizations, peer organizations, or any other type of organization. At step 84, each administrator of the one or more organizations creates user records for the administrators' respective organization to permit end users 42 and/or other organizations to associate with the respective organization. At step 86, the characteristics and the user records are stored in data storage tier 18. At step 88, administrators of the respective organizations administer the respective characteristics and user records using organizational admin devices 24. Administration of the organizations may include, among other things, defining data elements accessible for end users and/or other organizations, creating/modifying user records, providing content to the content library and app store, administering learning paths for end users, and performing any other administration of respective organizations. At step 90, administrators analyze data elements accessed by end users 42 and/or any associated organizations in order to administer the data elements provided to end users 42 and/or the associated organizations. These associated organizations are any organizations such as local, parent, grandparent, peer or other organizations with which the administrator's organization has a relationship. Analyzing data elements may be accomplished using data analytics provided by application 20.

### EXAMPLE

An example embodiment of application 20 is a Christian faith application. Content providers 40 include, among others, local churches, denominational organizations, church associations, parachurch organizations, and ministries. Local organization 44 is a local church. User 42 may be a member of the local church, or may be any other end user that wishes to associate with the local church. Based upon the membership or association with the local church, along with other possible criteria, an administrator of the local church organization establishes a relationship with the end user. A fee may be paid for the end user to have access to application 20. This fee may be either paid by the end user or the local church itself. The relationship between the end user and the local church organization is stored within data tier 18. The end user accesses application 20 through end user devices 22.

The local church organization may have relationships established with parent organizations 46 or grandparent organizations 48 such as church associations, denominational organizations, ministry organizations, or any other religious organizations. For example, the local church organization establishes a relationship with its parent denominational organization. This may or may not be a fee-based relationship. The denominational organization provides content for the local church within the content library or app store stored within application 20. The local church may also make the provided content available to the end user. The end user is also able to directly establish a relationship with the denominational organization. If the local church does not make the provided content available to the end user, the end user may still purchase the content from the content library or the app store through application 20.

The local church organization provides learning tracks for the end user. Learning materials and other content for the learning tracks are provided to the end user through the content library stored on data access tier 16 and data storage tier 18. The end user absorbs this material and progresses through the provided content. The local church organization monitors the progression of the end user through application 20 in order to provide further content to the end user. The local church may create these learning tracks, receive them from parent organizations, peer organizations, or other organizations through application 20, or purchase them from the content library and app store.

Other peer organizations may exist to provide content to the end user apart from the local church organization. These may be secular or religious organizations that provide content such as music, podcasts, blogs, counseling courses, digital books, and any other desired content. The peer organizations may pay a fee to provide this content and perform analytics on data usage within application 20. Other peer organizations may include ministries that do not have a local following. These organizations may provide content, materials and learning tracks that are free or available for a fee. These organizations can establish peer relationships with other organizations, parent type relationships, or relationships with end users.

The end user has a custom dashboard that is presented on user device 22 when accessing application 20. Information displayed on the custom dashboard is provided by user interface components 28a-28n. This information may include bible verses, podcasts, learning tracks from the local church or another organization, or any other information desired by the end user and provided by one of the organizations with which the end user is affiliated. This information also includes content from organizations that have relationships with the organizations with which the end user has a relationship. For example, if the local church organization has a relationship with a denominational organization, the end user may receive content from the denominational organization regardless of whether or not the end user has a direct established relationship with the denominational organization. The end user may also access the content library and app store through the custom dashboard.

Another end user may not have a local organization with which to associate. This user may still pay an access fee to obtain access to the content library and app store of application 20. This user would not be provided with directed content and learning tracks from a local organization, but would be able to access all of the content provided to the content library and app store for a fee. This may include content and learning tracks provided by other organizations, or made available to all users by local, parent, grandparent, or peer organizations.

Each organization is administered within application 20. This may be done automatically, or may be controlled by an administrative user. The administrative user accesses application 20 through admin access device 24. The administrative user has a user account stored within application 20 with which the administrative user authenticates. The user interface on admin access device 24 is provided by user interface components 28a-28n and allows the administrator to view data analytics for end user usage, learning track progress for end users, as well as content management for its content within the content library and app store of application 20. The administrator manages user records for its end users and/or manages the established relationships with other peer, parent, or subscribed/affiliated organizations.

While this example has been disclosed for a Christian faith application, other embodiments of application 20 include but are not limited to, for example, a health care application, a K-12 education application, a higher education application, a professional development application, other religious affiliations application, a finance or financial management application, a government application, or any other application for which users would benefit from directed content management and presentation from organizations.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method comprising:
defining first characteristics of a first organization, the first characteristics including a first set of data elements associated with the first organization;
storing the first characteristics of the first organization in a database;
establishing a first relationship between the first organization and an end user;
storing the first relationship in the database;
providing access to the first set of data elements stored in a database to the end user based upon the first relationship; and
accessing the first data elements through an electronic device controlled by the end user.

2. The method of claim 1, further comprising:
defining second characteristics of a second organization, the second characteristics including a second set of data elements associated with the second organization;
storing the second characteristics in the database;
establishing a second relationship between the second organization and the end user;
storing the second relationship in the database; and
providing access to the second set of data elements to the end user based upon the second relationship.

3. The method of claim 2, further comprising:
defining third characteristics of a third organization, the third characteristics including a third set of data elements associated with the third organization;
storing the third characteristics in the database;
establishing a third relationship between the third organization and the second organization;
storing the third relationship in the database; and
providing access to the third set of data elements to the end user based upon the second relationship and the third relationship.

4. The method of claim 3, wherein the third relationship is a parent-child relationship between the third organization and the second organization.

5. The method of claim 3, wherein the third relationship is a peer-to-peer relationship between the third organization and the second organization.

6. The method of claim 1, wherein accessing the first set of data elements through the electronic device comprises:
interfacing to an application server from the electronic device;
authenticating the first relationship through the application server;
presenting the first set of data elements to the end user through the first application server; and
accessing the first set of data elements from the database through the application server.

7. A system comprising:
a user tier that includes a first electronic access device controlled by an end user;
a data storage tier that includes application data and content data stored in a database, wherein the application data includes first characteristics defining a first organization, and wherein the first characteristics include a first set of data elements of the content data associated with the first organization;
an application tier that includes interface components that interface with the first electronic access device to allow access to the data storage tier; and
wherein access to the first set of data elements through the first electronic access device is permitted based upon a first established relationship between the end user and the first organization.

8. The system of claim 7, wherein electronic user access device interfaces with the application tier through a web browser.

9. The system of claim 7, wherein the application data further includes second characteristics defining a second organization, and wherein the second characteristics include a second set of data elements of the content data associated with the second organization, and wherein access to the second set of data elements through the first electronic access device is permitted based upon a second established relationship between the end user and the second organization.

10. The system of claim 9, wherein the application data further includes third characteristics defining a third organization, and wherein the third characteristics include a third set of data elements of the content data associated with the third organization, and access to the third set of data elements through the first electronic access device is permitted based upon a parent relationship established between the second organization and the third organization.

11. The system of claim 10, wherein the application data further includes fourth characteristics defining a fourth organization, and wherein the fourth characteristics include a fourth set of data elements of the content data associated with the fourth organization, and access to the fourth set of data elements through the first electronic access device is permitted based upon a peer-to-peer relationship established between the second organization and the fourth organization.

12. The system of claim 7, wherein the access tier further includes a load balancer to distribute a load to the interface components.

13. The system of claim 7, wherein a subset of the interface components are implemented as virtual machines.

14. The system of claim 7, wherein the user tier further includes a second user access device controlled by an administrative user, wherein the administrative user defines and controls the first characteristics of the first organization, and wherein the administrative user controls the first characteristics based in part upon accessed data of the first set of data elements accessed by the end user.

15. A method comprising:
defining first characteristics of a first organization, wherein the first characteristics include a first selected set of content data stored on a data server;
permitting an end user to associate with the first organization by creating a user record within the first characteristics that belongs to the end user;
storing the first characteristics on the data server;
administering the first characteristics through an electronic access device; and
analyzing data elements of the first selected set of content data accessed by the end user.

16. The method of claim 15, wherein the end user accesses the data elements through a web browser on an electronic end user device.

17. The method of claim 15, further comprising:
defining parent characteristics of a parent organization, wherein the parent characteristics includes a second selected set of content data stored on the data server, and an established relationship with the first organization; and
storing the parent characteristics on the data server.

18. The method of claim 17, further comprising:
defining grandparent characteristics of a grandparent organization, wherein the grandparent characteristics includes a third selected set of content data stored on the data server, and an established relationship with the parent organization; and
storing the grandparent characteristics on the data server.

19. The method of claim 15, further comprising:
defining peer characteristics of a peer organization, wherein the peer characteristics includes a fourth selected set of content data stored on the data server and an established relationship with the first organization; and
storing the peer characteristics on the data server.

20. The method of claim 17, further comprising:
defining peer characteristics of a peer organization, wherein the peer characteristics includes a fourth selected set of content data stored on the data server and an established relationship with the parent organization; and
storing the peer characteristics on the data server.

21. The method of claim 18, further comprising:
defining peer characteristics of a peer organization, wherein the peer characteristics includes a fourth selected set of content data stored on the data server and an established relationship with the grandparent organization; and
storing the peer characteristics on the data server.

22. The method of claim 17, wherein the first selected set of content data stored on the data server includes the second selected set of content data stored on the data server based upon the established relationship between the parent organization and the first organization.

23. The method of claim 18, wherein the first selected set of content data stored on the data server includes the third selected set of content data stored on the data server based upon the established relationship between the grandparent organization and the parent organization.

24. The method of claim 19, wherein the first selected set of content data stored on the data server includes the fourth selected set of content data stored on the data server based upon the established relationship between the peer organization and the first organization.

25. The method of claim 20, wherein the second selected set of content data stored on the data server includes the fourth selected set of content data stored on the data server based upon the established relationship between the peer organization and the parent organization.

26. The method of claim 21, wherein the third selected set of content data stored on the data server includes the fourth selected set of content data stored on the data server based upon the established relationship between the peer organization and the grandparent organization.

27. The method of claim 15, wherein administering the first characteristics comprises updating the first set of content data based upon analysis of the data elements accessed by the end user.

28. The method of claim 17, further comprising administering the parent characteristics, wherein administering the parent characteristics includes updating the second set of content data based upon analysis of data usage of at least one of the first organization and the end user.

29. The method of claim 18, further comprising administering the grandparent characteristics, wherein administering the grandparent characteristics includes updating the third set of content data based upon analysis of data usage of at least one of the parent organization, the first organization, and the end user.

30. The method of claim 19, further comprising administering the peer characteristics, wherein administering the peer characteristics includes updating the fourth set of content data based upon analysis of data usage of the first organization.

31. The method of claim 20, further comprising administering the peer characteristics, wherein administering the peer characteristics includes updating the fourth set of content data based upon analysis of data usage of the parent organization.

32. The method of claim 21, further comprising administering the peer characteristics, wherein administering the peer characteristics includes updating the fourth set of content data based upon analysis of data usage of the grandparent organization.
